(19) United States
(12) Patent Application Publication
(10) Pub. No.: US 2025/0171234 A1
(43) Pub. Date: May 29, 2025

(54) INTELLIGENT WAREHOUSE STORAGE BIN ALLOCATION SYSTEM

(71) Applicants: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/522,248

(22) Filed: Nov. 29, 2023

(51) Int. Cl. B65G 1/137

(52) U.S. Cl. CPC B65G 1/1373; B65G 1/1371

(57) ABSTRACT

An intelligent warehouse storage bin allocation system includes a goods information unit having goods information; a warehouse information unit having storage bin information; a data transmission unit for receiving and transmitting the goods information and the storage bin information to an intelligent computing unit for generating a goods label unit and a storage bin label unit; a storage unit for storing content of the goods label unit and the storage bin label unit; and a terminal unit having an acquiring unit, a display unit, an instruction unit, and a comparison unit. When the comparison unit determines a match between the goods label unit and the storage bin label unit, the terminal unit displays a shelving-approved command and a specified warehouse position for the goods. Through this system, effective and precise intelligent allocation of goods during the shelving and retrieval processes can be achieved, improving work efficiency.

### BACKGROUND OF THE INVENTION

### Fields of the Invention

The present invention relates to a technical field of warehouse management and, more particularly to, an intelligent warehouse storage bin allocation system.

### Descriptions of Related Art

With the increasing market competition and rapid development of international trade, many businesses are beginning to focus on the efficiency of warehouse management. Most existing warehouse management systems still rely on paper documents to record information related to goods in and out. Moreover, when goods enter the warehouse, the placement of goods on shelves typically is determined by warehouse personnel based on their experience. This approach not only fails to achieve standardized warehouse management but also has a high error rate, affecting the efficiency of goods handling. Therefore, developing a goods shelving management system that can improve work efficiency and reduce operational costs is crucial for businesses and becomes one of the primary research topics of the present invention.

### SUMMARY OF THE INVENTION

The primary objective of the intelligent warehouse storage bin allocation system according to the present invention is to provide an efficient and accurate intelligent allocation for the shelving and retrieval processes of goods, enhancing work efficiency.

To achieve the above objective, the present invention provides an intelligent warehouse storage bin allocation system, comprising a goods information unit provided on goods and having goods information; a warehouse information unit having storage bin information; a data transmission unit for receiving and transmitting the goods information and the storage bin information to an intelligent computing unit which can generate a goods label unit and a storage bin label unit through AI-based computation; a storage unit for storing content of the goods label unit and the storage bin label unit; and a terminal unit having an acquiring unit, a display unit, an instruction unit, and a comparison unit in mutual connection. The acquiring unit is configured to acquire and display the content of the goods information unit and the storage bin label unit on the display unit. The instruction unit is configured to input a confirmation command transmitted to the intelligent computing unit. The intelligent computing unit can display the content of the goods label unit on the display unit. The comparison unit can compare and determine whether the content of the goods label unit and the content of the storage bin label unit match. When the content of the goods label unit perfectly matches the content of the storage bin label unit, the terminal unit displays a shelving-approved command and a specified warehouse position for storage of the goods. Accordingly, through this system, effective and precise intelligent allocation of goods during the shelving and retrieval processes can be achieved, improving work efficiency.

In the present invention, the storage bin label unit can divide warehouse positions for storage of the goods based on the content of the storage bin information, and the goods label unit is provided on the goods and is linked to the storage bin label unit, thus having the corresponding content with the storage bin label unit.

In the present invention, the goods content has goods name, goods type, goods inbound date, goods outbound date, goods volume, and customer inventory history information.

In the present invention, the storage bin content has inbound date, outbound date, storage bin location, storage bin quantity, and storage bin attribute.

In the present invention, the goods label unit and the storage bin label unit can be RFID electronic information.

In the present invention, the acquiring unit can acquire the content of the goods information unit and the content of the storage bin label unit by scanning or photographing.

In the present invention, the terminal unit can be a personal digital assistant (PDA), phone, or tablet.

In the present invention, the system further comprises a release unit for releasing a shelving-denied command of the terminal unit and switching to a manual shelving mode.

In the present invention, the storage bin label unit can divide warehouse positions for the goods based on the content of the storage bin information, and the goods label unit corresponds to the content of the storage bin label unit.

### BRIEF DESCRIPTION OF THE DRAWINGS

FIG. 1 is a system block diagram of the present invention.

FIG. 2 is a system block diagram of a goods information unit of the present invention.

FIG. 3 is a system block diagram of a warehouse information unit of the present invention.

FIG. 4 is a system block diagram of a terminal unit of the present invention.

FIG. 5 is a flow schematic diagram to use the system of the present invention.

### DETAILED DESCRIPTION OF THE PREFERRED EMBODIMENT

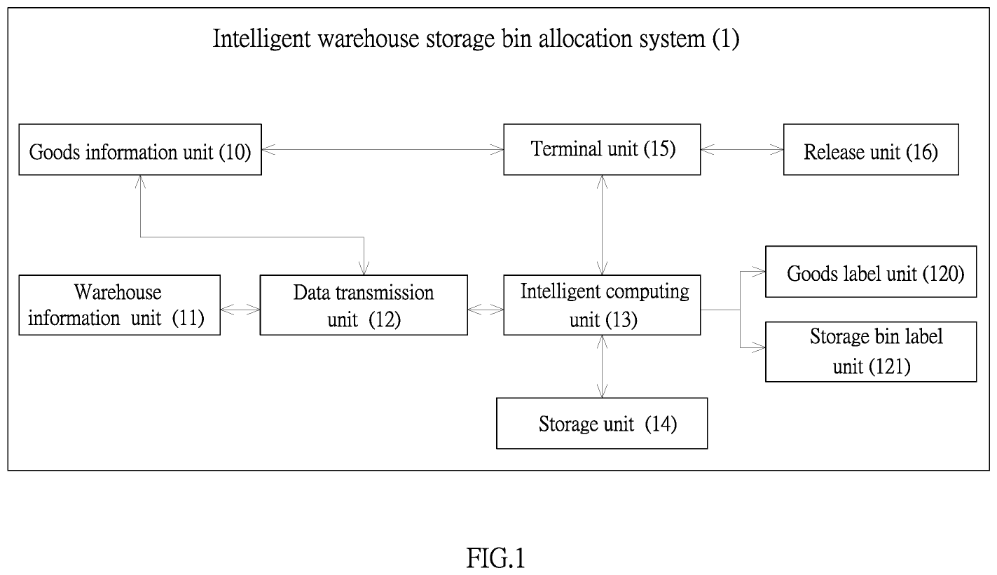

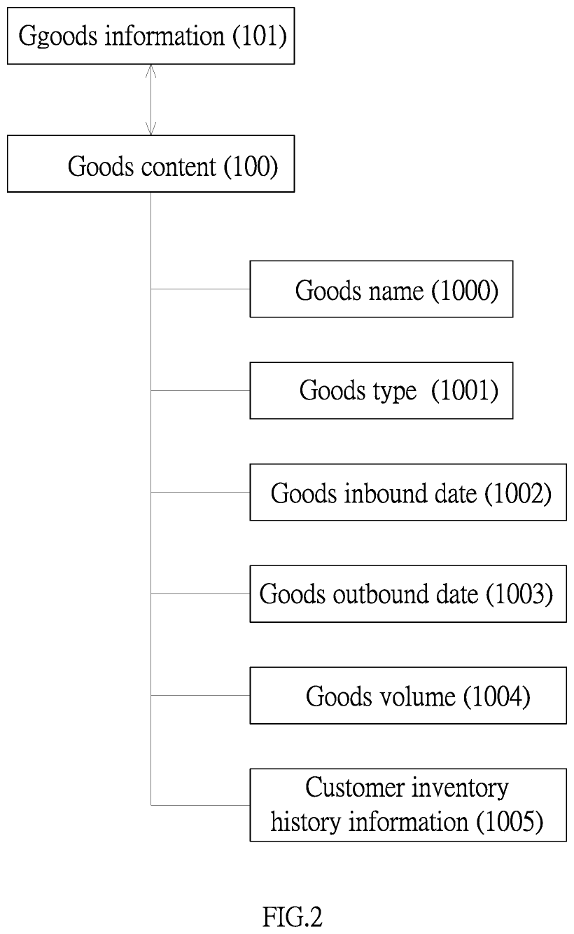

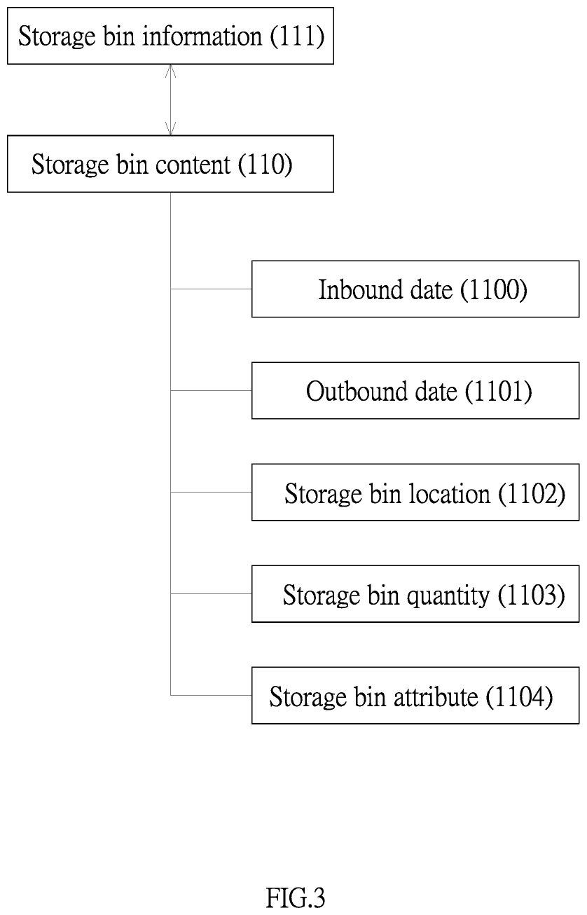

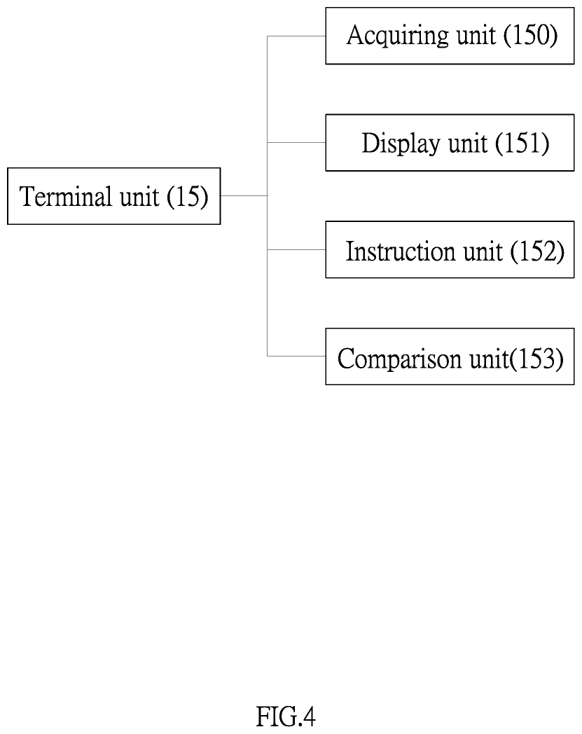

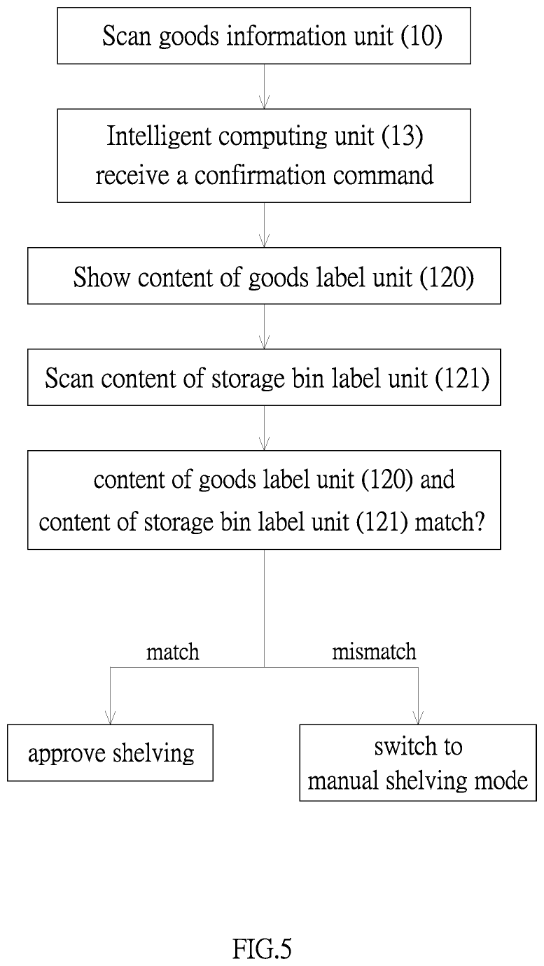

As shown in FIGS. 1 to 5, the present invention provides an intelligent warehouse storage bin allocation system 1, comprising: a goods information unit 10, a warehouse information unit 11, a data transmission unit 12, an intelligent computing unit 13, a storage unit 14, and a terminal unit 15 in mutual connection.

The goods information unit 10 is provided on goods or a packaging box of goods, and has goods content 100 including goods name 1000, goods type 1001, goods inbound date 1002, goods outbound date 1003, goods volume 1004, and customer inventory history information 1005. The goods information unit 10 generates goods information 101 based on the aforementioned goods content 100.

The warehouse information unit 11 has storage bin content 110, including: inbound date 1100, outbound date 1101, storage bin location 1102, storage bin quantity 1103, and storage bin attribute 1104. The warehouse information unit 11 generates storage bin information 111 based on the aforementioned storage bin content 110.

The data transmission unit 12 receives and transmits the goods information 101 and the storage bin information 111 from the goods information unit 10 and warehouse information unit 11 to the intelligent computing unit 13. The intelligent computing unit 13, upon receiving the goods information 101 and the storage bin information 111, generates a goods label unit 120 and a storage bin label unit 121 through artificial intelligence computation. The storage bin label unit 121 divides the warehouse positions where each batch of goods should be stored based on the storage bin information 111. The goods label unit 120 is provided on the goods or the packaging box of goods and is linked to the storage bin label unit 121, thus having corresponding content with the storage bin label unit 121. In this embodiment, the goods label unit 120 and the storage bin label unit 121 can be RFID electronic information.

The storage unit 14 receives and stores the content of the goods label unit 120 and the storage bin label unit 121 from the intelligent computing unit 13.

The terminal unit 15 has an acquiring unit 150, a display unit 151, an instruction unit 152, and a comparison unit 153 in mutual connection.

The acquiring unit 150 is used to acquire the content of the goods information unit 10 and the storage bin label unit 121 and display it on the display unit 151. The instruction unit 152 is used to input a confirmation command transmitted to the intelligent computing unit 13. The intelligent computing unit 13, upon receiving the confirmation command, displays the content of the goods label unit 120 on the display unit 151. The comparison unit 153 compares the content of the goods label unit 120 with the content of the storage bin label unit 121 and determines whether they match. In this embodiment, the terminal unit 15 can be a multimedia mobile device, such as a personal digital assistant (PDA), phone, or tablet.

The application of the present invention is further explained. Warehouse personnel use the acquiring unit 150 of the terminal unit 15 to obtain the content of the goods information unit 10 for a batch of goods by scanning or photographing and can know the content of the goods information 101 through the display unit 151. If the warehouse personnel agree with the content of the goods information 101, they input a confirmation command through the instruction unit 152 and send it to the intelligent computing unit 13. The intelligent computing unit 13, upon receiving the confirmation command from the instruction unit 152, displays the content of the goods label unit 120 on the display unit 151. As such, the warehouse personnel can know the warehouse position where the batch of goods should be stored through the goods label unit 120. Subsequently, the warehouse personnel go to the warehouse position 3 and use the acquiring unit 150 to obtain the content of the storage bin label unit 121 on the warehouse position 3 by scanning or photographing. After the terminal unit 15 obtains the content of the goods label unit 120 and the storage bin label unit 121, the comparison unit 153 compares the content of the goods label unit 120 with the content of the storage bin label unit 121. When the content of the goods label unit 120 matches the content of the storage bin label unit 121, the terminal unit 15 displays a shelving-approved command and the warehouse position on the display unit 151. The warehouse personnel can then store the batch of goods in the specified warehouse position. On the other hand, if the comparison unit 153 determines that the content of the goods label unit 120 does not match the content of the storage bin label unit 121, the display unit 151 of the terminal unit 15 will display a shelving-denied command with no warehouse position displayed. Therefore, the warehouse personnel cannot know the warehouse position where the batch of goods should be stored. To solve this problem, the intelligent warehouse storage bin allocation system 1 of the present invention further includes a release unit 16, which is used to release the shelving-denied command of the terminal unit 15. Specifically, when the comparison unit 153 determines a mismatch between the content of the goods label unit 120 and the content of the storage bin label unit 121, followed by displaying a shelving-denied command on the display unit 151 of the terminal unit 15 without providing the warehouse position, the warehouse personnel can use the release unit 16 to send a release command to the intelligent computing unit 13. When the intelligent computing unit 13 receives the release command from the release unit 16, the shelving-denied command provided by the terminal unit 15 can be released. The reason for providing the function of releasing the shelving-denied command is that when there is an emergency in the warehouse, the system can switch to manual shelving mode. The warehouse personnel can determine the warehouse position where the batch of goods should be stored according to the current situation, avoiding delays in the shelving operation of goods.

In summary, the present invention provides an intelligent warehouse storage bin allocation system for intelligent distribution and shelving of goods, making warehouse management more accurate and solving problems such as disorderly storage bin positions in the warehouse and low operational efficiency caused by excessive reliance on warehouse personnel.

What is claimed is:

1. An intelligent warehouse storage bin allocation system, comprising: a goods information unit, a warehouse information unit, a data transmission unit, an intelligent computing unit, a storage unit, and a terminal unit in mutual connection, wherein:
the goods information unit is provided on goods and has goods content and is configured to generate goods information based on the goods content;
the warehouse information unit has storage bin content and is configured to generate storage bin information based on the storage bin content;
the data transmission unit is configured to receive and transmit the goods information and the storage bin information from the goods information unit and warehouse information unit to the intelligent computing unit;
the intelligent computing unit, upon receiving the goods information and the storage bin information, generates a goods label unit and a storage bin label unit through artificial intelligence computation, the goods label unit being provided on the goods and corresponding to content of the storage bin label unit;
the storage unit is configured to receive and store content of the goods label unit and the storage bin label unit from the intelligent computing unit; and
the terminal unit has an acquiring unit, a display unit, an instruction unit, and a comparison unit in mutual connection, wherein (i) the acquiring unit is configured to acquire and display the content of the goods information unit and the storage bin label unit on the display unit, (ii) the instruction unit is configured to input a confirmation command transmitted to the intelligent computing unit, (iii) the intelligent computing unit, upon receiving the confirmation command, displays the content of the goods label unit on the display unit, (iv) the comparison unit is configured to compare the content of the goods label unit with the content of the storage bin label unit and determine whether the content of the goods label unit and the content of the storage bin label unit match, and (v) when the comparison unit determines a perfect match between the content of the goods label unit and the content of the storage bin label unit, the terminal unit displays a shelving-approved command and a specified warehouse position for storage of the goods on the display unit.

2. The intelligent warehouse storage bin allocation system as claimed in claim 1, wherein the storage bin label unit is configured to divide warehouse positions for storage of the goods based on the storage bin information, and the goods label unit is provided on the goods and is linked to the storage bin label unit, thus having corresponding content with the storage bin label unit.

3. The intelligent warehouse storage bin allocation system as claimed in claim 1, wherein the goods content has goods name, goods type, goods inbound date, goods outbound date, goods volume, and customer inventory history information.

4. The intelligent warehouse storage bin allocation system as claimed in claim 1, wherein the storage bin content has inbound date, outbound date, storage bin location, storage bin quantity, and storage bin attribute.

5. The intelligent warehouse storage bin allocation system as claimed in claim 1, wherein the goods label unit and the storage bin label unit are RFID electronic information.

6. The intelligent warehouse storage bin allocation system as claimed in claim 1, wherein the acquiring unit is configured to acquire the content of the goods information unit and the content of the storage bin label unit by scanning or photographing.

7. The intelligent warehouse storage bin allocation system as claimed in claim 1, wherein the terminal unit is a personal digital assistant (PDA), phone, or tablet.

8. The intelligent warehouse storage bin allocation system as claimed in claim 1, further comprising a release unit for releasing a shelving-denied command of the terminal unit and switching to a manual shelving mode.

9. The intelligent warehouse storage bin allocation system as claimed in claim 1, wherein the storage bin label unit is configured to divide warehouse positions for the goods based on the storage bin information, and the goods label unit corresponds to the content of the storage bin label unit.
